(19) United States
(12) Patent Application Publication
(10) Pub. No.: US 2026/0300451 A1
(43) Pub. Date: Oct. 1, 2026

(54) TOPIC-BASED WATERMARKING FOR LARGE LANGUAGE MODELS

(71) Applicant: CASE WESTERN RESERVE UNIVERITY, CLEVELAND, OH (US)

(72) Inventors: Erman Ayday, Cleveland, OH (US); Alexander Nemecek, Seven Hills, OH (US); Yuzhou Jiang, Westlake, OH (US)

(21) Appl. No.: 19/632,922

(22) Filed: Mar. 30, 2026

Related U.S. Application Data
(60) Provisional application No. 63/780,575, filed on Mar. 31, 2025.

(51) Int. Cl. G06F 21/16; G06F 40/30

(52) U.S. Cl. CPC G06F 21/16; G06F 40/30

(57) ABSTRACT

A computer-implemented method can include receiving, at language model, an input prompt. The method can also include determining a semantic topic associated with the input prompt. The method can also include adjusting token selection probabilities to favor tokens aligned with the semantic topic. The method can also include generating output text using the adjusted probabilities, whereby usage of tokens in the output text encodes a topic-based watermark.

### RELATED APPLICATION

This application claims priority from U.S. Provisional Application No. 63/780,575, filed Mar. 31, 2025, the subject matter of which is incorporated herein by reference in its entirety.

### TECHNICAL FIELD

This description relates to language models and their use and, more particularly, topic-based watermarking for large language models.

### BACKGROUND

Large language models (LLMs) are capable of generating human-like text across a wide range of domains. As adoption increases, it becomes desirable to distinguish machine-generated text from human-authored text for purposes including provenance verification, authenticity validation, and misuse mitigation. One technique to verify origin of machine-generated text is referred to as watermarking, which involves embedding invisible signals in the text generated by an LLM. Existing watermarking techniques tend to reduce output quality, be vulnerable to paraphrasing or lexical modification, and usually require significant architectural modifications or post-processing frameworks.

### SUMMARY

This description relates to large language models and their use and, more particularly, topic-based watermarking for large language models.

One example provides a system that includes A computer-implemented method can include receiving, at language model, an input prompt. The method can also include determining a semantic topic associated with the input prompt. The method can also include adjusting token selection probabilities to favor tokens aligned with the semantic topic. The method can also include generating output text using the adjusted probabilities, whereby usage of tokens in the output text encodes a topic-based watermark.

Another example provides a system that includes one or more processors and memory storing machine-readable instructions. When the machine-readable instructions are executed by the one or more processors, they cause the one or more processors to at least:
receive an input prompt;
generate, based on the input prompt, logits for candidate tokens using a large language model;
adjust the logits to bias token selection toward a topic-based subset of tokens; and
generate output text using the adjusted logits, whereby usage of tokens in the output text encodes a topic-based watermark.

Yet another example provides a computer-implemented method of detecting watermarking in text can include receiving a text sequence. The method can also include computing a score representing a frequency of tokens for the text sequence associated with at least one topic of a plurality of predefined semantic topics for a vocabulary of a large language model. The method can also include comparing the score to a threshold and determining whether the text sequence includes a watermark based on the comparison.

### BRIEF DESCRIPTION OF THE DRAWINGS

FIG. 1 is a block diagram showing an example of a system configured to perform token-to-topic mapping.

FIG. 2 is diagram showing a simplified example of partitioning a vocabulary into topic-aligned subsets of tokens for use in topic-based watermarking.

FIG. 3 depicts an example algorithm that can be implemented to perform token-to-topic mapping.

FIG. 4 is a block diagram showing an example of a system configured to perform topic-based watermarking.

FIG. 5 depicts an example algorithm that can be implemented to perform topic-based watermarking.

FIG. 6 depicts an example algorithm that can be implemented to perform topic-based watermark detection.

FIG. 7 is a block diagram of a computing system that can be configured to perform topic-based watermarking and topic-based watermark detection.

FIGS. 8 and 9 are graphs depicting a comparison of text perplexity for a plurality of different LLMs.

FIG. 10 is a graph demonstrating a comparison of generation time for different watermarking methods at different token lengths.

FIG. 11 are graphs demonstrate comparison of true positive rate at false positive rate for different watermarking methods.

FIG. 12 is a graph demonstrating a comparison of detection scores as a function of bias strength for topic-based watermarking implemented according an example embodiment.

FIG. 13 is a graph demonstrating an example of detection strength as a function of the number of topics for topic-based watermarking implemented according an example embodiment.

FIG. 14 is a graph demonstrating an example of text quality as a function the number of topics for topic-based watermarking implemented according an example embodiment.

FIG. 15 is a scatter plot showing detection z-scores as a function of text quality for topic-based watermarking implemented according an example embodiment.

### DETAILED DESCRIPTION

This disclosure relates to topic-based watermarking for large language models (LLMs) and to detecting such watermarking. The systems and methods are adapted to embed signals, defining a detectable watermark, into machine-generated text by biasing token selection in a manner aligned with a semantic topic of an input prompt.

As an example, a semantic topic can be identified responsive to an input prompt received by an LLM. The LLM includes a vocabulary that is partitioned into token subsets (also referred to herein as topic-aligned subsets or topic-aligned token lists) associated with a set of semantic topics. The semantic topics can be selected by the model operator (or owner) according to an intended use for the model, such as may be a general or specific use case. One or more of the topic-aligned subsets are selected for the input prompt. A bias is applied to tokens within the selected subset(s). For example, the bias can be applied by modifying logits generated by a neural network implemented by the LLM for tokens in the subset of tokens. Thus, during decoding, token selection probabilities will be biased in favor of tokens within the selected subset, such that the sequence of tokens generated as text exhibit statistically detectable token usage patterns aligned with the selected topic-aligned subset. Because the bias is semantically consistent with the input prompt, text quality and fluency (e.g., evaluated via perplexity performance) are preserved while enabling watermark detection. Additionally, the topic-based watermarking technology disclosed herein increases robustness because paraphrasing attacks are less effective and semantic consistency throughout the document can reinforce preserving the watermark and text quality in a stealthy manner.

As described herein, for example, watermark detection can be implemented on text via a publicly available interface. The interface can access a detection algorithm, which can be controlled by the model operator. The detection algorithm can be used to compute a score (e.g., a z-score) that can be used to classify whether text is watermarked or not.

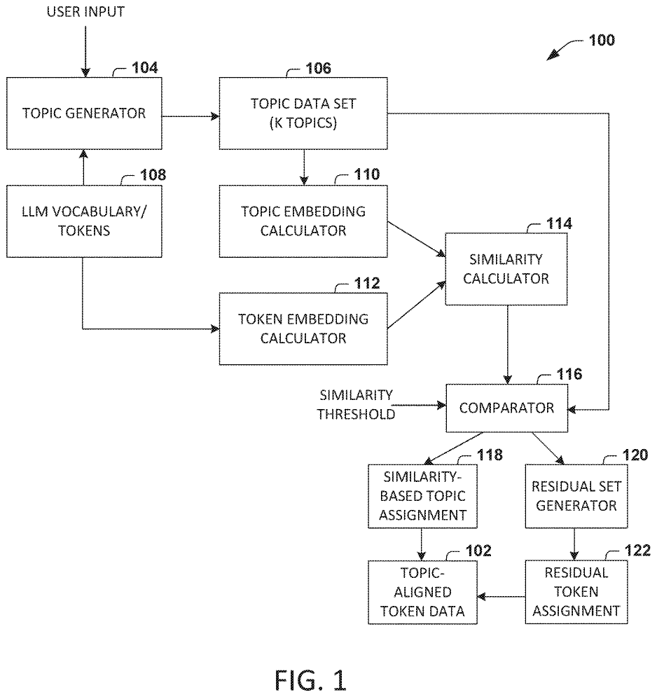

FIG. 1 is a block diagram showing an example of a system 100 configured to perform token-to-topic mapping for generating topic-aligned token data 102. The system 100 can be implemented by one or more computing systems, such as described herein. Also, or alternatively, the system 100 can be implemented using software frameworks such as machine learning frameworks, neural network libraries, or numerical computation libraries. The software may execute on an operating system such as Linux, Windows, or macOS. For example, the system 100 can be implemented as machine-readable instructions (e.g., program code) that, when executed by one or more processors (also referred to herein as a processor), cause the processor to perform the functions described herein.

In the example of FIG. 1, the system 100 includes a topic generator 104 programmed to cause the processor to generate a topic data set 106, such as including K semantic topics (where K is a positive integer representative of the number of topics). The topic generator 104 can generate the topic data set 106 responsive to a user input and based on an LLM vocabulary 108 used by the LLM. The topics can be determined to represent semantic concepts for the LLM vocabulary. Additionally, the number of topics K to be generated by the topic generator 104 can be a default parameter or be a variable parameter that can be set to a desired value responsive to a user input. For example, the user input(s) can be provided by an authorized user of the LLM, such as a developer of the LLM or another individual authorized by the owner or operator of the LLM, such as to define a desired set of topics for the topic data set 106 for use by the LLM. The topics represented in the topic data set 106 can be general topics to accommodate a broad set of queries and use cases. Alternatively, the topics represented in the topic data set 106 can be more specific for a particular use case (e.g., topics related to education, finance, politics, technology, and the like).

Also, or alternatively, topics in the topic data set 106 can include one or more subtopics, such as arranged in a hierarchy of semantic groupings, in which subtopics under a given topic are semantically related to the given topic. Subtopics can include additional levels of hierarchy under the subtopics according to a desired level of semantic granularity that might be desired for implementing topic-based watermarking as described herein. A topic list (also referred to as a “green list”) can be generated for each topic and subtopic (if used) to which tokens can be appended for generating the topic-aligned token data 102, as described herein.

The system 100 also includes a topic embedding calculator 110 and a token embedding calculator 112. The topic embedding calculator 110 can cause the processor to compute topic embeddings for the topics (and any subtopics) defined by the topic data set 106. The topic embedding calculator 110 can tokenize the topics and convert (e.g., by using a deep neural network) the corresponding tokens into numerical representations (e.g., vectors) that characterize the semantic meaning of the topics. The token embedding calculator 112 can cause the processor to compute token embeddings for tokens in (or derived from) the LLM vocabulary 108. For example, the LLM vocabulary can be tokenized into respective tokens and the token embedding calculator 112 convert (e.g., by using a deep neural network) the corresponding tokens into numerical representations (or vectors) that characterize the semantic meaning of the respective tokens.

As used herein, tokens refer to the basic units of text input that the LLM can process. For example, tokens can be words, parts of words (e.g., subword units), and/or include punctuation marks. The types particular units of text that can form tokens can vary depending on the tokenization method used by the LLM.

A similarity calculator 114 can be configured to compute a similarity value (e.g., a similarity score) between each of the token embeddings (e.g., provided by the token embedding calculator 112) and each of the topic embeddings (e.g., provided by the topic embedding calculator 110). As one example, the similarity calculator can be configured to compute a cosine similarity between each token embedding and each topic embedding. Other similarity metrics are possible, such as a classifier probability or distance metric. A comparator 116 is configured to compare the computed similarity value relative to a similarity threshold (also referred to herein as τ). If the computed similarity value exceeds the similarity threshold, a similarity-based topic assignment function 118 can be configured to assign (e.g., append) the token to a topic list associated with the respective topic that forms the topic-aligned token data 102. In some example, if the similarity for a respective token exceeds the threshold for more than one topic, the similarity-based topic assignment function 118 can assign the token to the topic for which the maximum similarity value was computed, such that each token exists only in one topic list. In examples where partially overlapping subsets of tokens is permitted, if the similarity for a respective token exceeds the threshold for more than one topic, the similarity-based topic assignment function 118 can assign the token to the topic list for each topic exceeding the similarity threshold. The threshold τ can be fixed or a programmable parameter (e.g., a hyperparameter) to control semantic alignment and coherency of topic coverage.

If the maximum similarity for a token does not exceed the similarity threshold τ for any topic (as determined by the comparator 116), a residual set generator 120 is configured to cause the processor to add (e.g., append) to token to a residual set of tokens. A residual token assignment function 122 can be configured to add each of the residual tokens to one of the K topics. In an example, residual token assignment function 122 can distribute the residual tokens among the topic lists in a round-robin manner until all the residual tokens have been added to a topic list of the topic-aligned token data 102. This helps to ensure comprehensive coverage of the entire vocabulary, preventing any token from being discarded. In some examples, the similarity score may be stored with each token in the respective topic list (or lists) as part of the topic-aligned token data 102.

The topic-aligned token data 102 can stored in memory as part of the configuration files for the LLM for performing topic-based watermarking as describe herein. The topic-aligned token data 102 include multiple disjoint subsets of tokens without overlap. Alternatively, the topic-aligned token data 102 can include partially overlapping subsets of tokens, in which tokens may belong to multiple topic subsets. As a further example, more than one set of topic-aligned token data 102 can be generated for a given LLM. For example, different sets of topic-aligned token data 102 can be generated for different use cases and/or different groups of users (e.g., based on subscription details, user profile, location, and/or other context or task specific information), such that responsive to identifying the LLM being accessed for a particular use case and/or by a user belonging to a particular group, an associated set of the topic-aligned token data 102 can be identified and loaded into memory during operation of the LLM to enable topic-based watermarking more semantically tailored to use case and/or user.

The topic-aligned token data 102 can be stored in memory for use by the LLM. As examples, the topic-aligned token data 102 can be stored as part of the vocabulary 108 or as a separate data structure that is programmatically linked to or otherwise associated with the vocabulary. In some examples, the system 100 can be utilized to generate an updated set of the topic-aligned token data 102 in response to detecting changes in the vocabulary 108 or other conditions associated with the LLM.

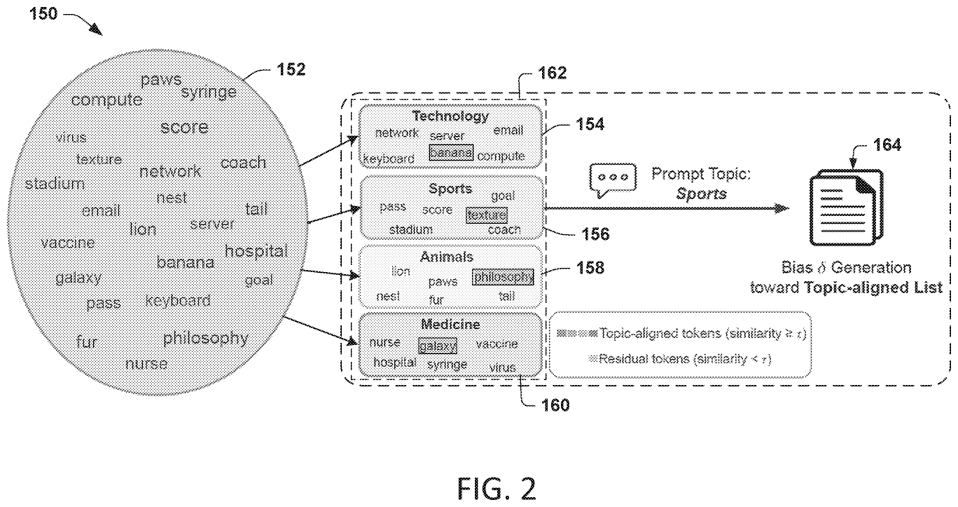

FIG. 2 is diagram 150 showing an example of partitioning a simplified LLM vocabulary 152 (e.g., LLM vocabulary 108) into topic-aligned subsets of tokens 154, 156, 158, and 160 for use in topic-based watermarking. The partitioning of the vocabulary can be implemented by the system 100 of FIG. 1. Accordingly, the description of FIG. 2 may refer to certain aspects of FIG. 1. In the example of FIG. 2, a topic data set for the vocabulary 152 is generated (e.g., by topic generator 104 responsive to a user input) for a set of general topics that include technology, sports, animals, and medicine topics. Other general or more specific topics can be chosen in other examples. While the example of FIG. 2 shows four topics, the approach described herein is equally applicable to larger numbers of topics as well as include subtopics for more fine-grained coverage, such as to accommodate a larger vocabulary V and additional semantic concepts. The topic-aligned subsets of tokens 154, 156, 158, and 160 define topic-aligned token data 162 (e.g., corresponding to the topic-aligned token data 102).

The diagram 150 also depicts a high-level example of generating output text that include a topic-based watermark, in which the input prompt results in identifying sports list of tokens as the active green list for purpose of watermarking. For example, during decoding and prior to sampling, selection probabilities of tokens in the sports topic-aligned subset of tokens 156 are biased (e.g., by biasing logit values) to favor selecting tokens aligned with the semantic topic of sports. As a result of biasing token selection towards sports, the LLM generates output text 164 that encodes a statistically detectable sports-based watermark.

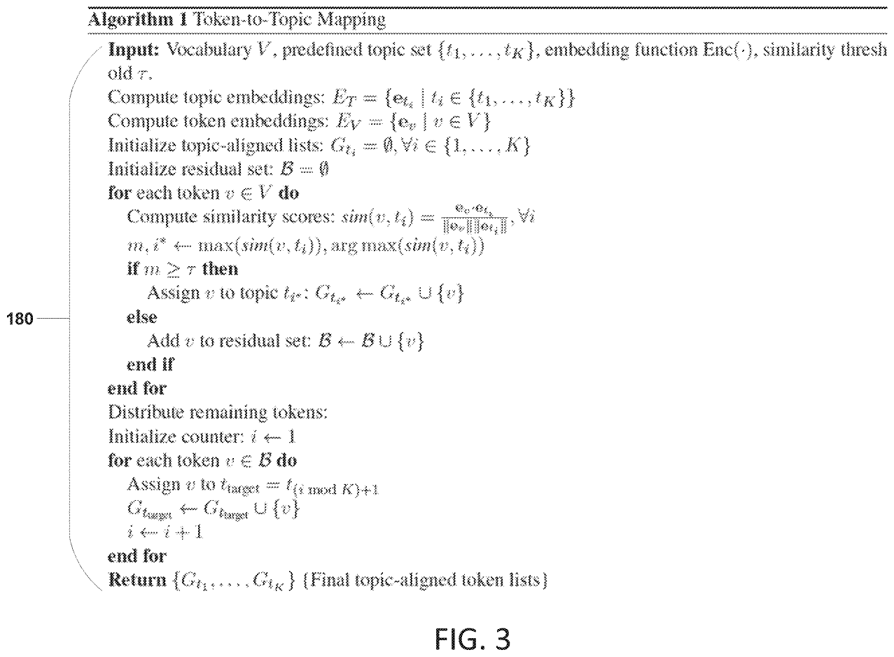

FIG. 3 depicts an example algorithm 180 that can be implemented to perform token-to-topic mapping for generating topic-aligned token data 102. The algorithm 180 can be used to implement the system 100 of FIG. 1 for generating topic-aligned token data (e.g., topic-aligned token data 102) for a predefined topic set (t₁, . . . , t_{K}), such as can include topics as described herein. Accordingly, the description of FIG. 3 can also refer to certain aspects of FIGS. 1 and 2. For example, the algorithm 180 can receive as inputs an LLM vocabulary V, the topic set (t₁, . . . , t_{K}), an embedding function (e.g., an embedding model), and a similarity threshold τ (e.g., a hyperparameter). Additional parameters can include topic aligned lists Gₜ_{ᵢ} and residual sets.

As a further example, after initializing parameter to starting values, each token v∈V can be encoded into a token embedding eᵥ and each topic (t₁, . . . , t_{K}) can be encoded into a topic embedding eₜ_{ᵢ}. As one example, the all-MiniLM-L6-v2 model can be used as the embedding function (e.g., calculators 110 and 112) to generate the token and topic embeddings. In other examples, any semantic embedding framework can be implemented as the embedding function, which can tailor the mapping for domain-specific or resource-constrained environments.

The algorithm 180 further includes similarity code, shown as sim(v, tᵢ) (e.g., similarity calculator 114) to compute a similarity between each token embedding eᵥ each topic embedding eₜ_{ᵢ}. If the maximum similarity across all topics exceeds the threshold τ, the token is assigned to the corresponding topic's “green list” Gₜ_{ᵢ}. Tokens that do not exceed τ for any topic are collected into a residual set (e.g., generated by residual set generator 120), which is subsequently distributed among {Gₜ_{₁} . . . Gₜ_{_{1K}}} in a round-robin manner. This ensures comprehensive coverage of the entire vocabulary, preventing any token from being discarded. The hyperparameter τ controls the granularity of semantic alignment and comprehensive topic coverage for the algorithm 180. For example, a higher τ enforces stronger coherence but increases the proportion of tokens allocated via the round-robin mechanism.

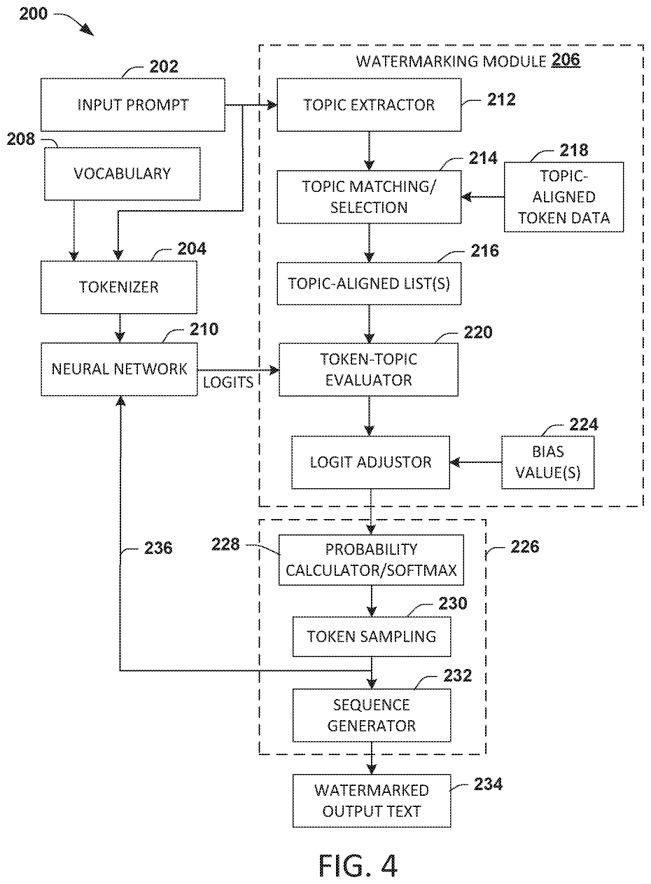

FIG. 4 is a block diagram showing an example of an LLM system 200 configured to perform topic-based watermarking. The LLM system 200 can be implemented by one or more computing systems, such as described herein. Also, or alternatively, the LLM system 200 can be implemented using software frameworks.

In the example of FIG. 4, the LLM system 200 receives an input prompt 202 through one or more interface. In one example, the input prompt 202 is received via an application programming interface (API), such as from a client device that transmits a request including the input prompt over a network or other communications link (e.g., secure channel or cryptographic link). In other examples, the input prompt 202 is received through a user interface, such as a graphical user interface (GUI), in which a user enters text into an input field via an input device (e.g., keyboard, mouse, microphone, etc.). The input prompt 202 can include a text sequence. Also, or alternatively, the input prompt can be received in other modalities for processing by the LLM, such as a voice prompt and/or include one or more images. In the following example, it is presumed that the input prompt include text, which can be entered directly or converted from speech to text using a speech recognition module (not shown).

The LLM system 200 can include a tokenizer 204 and watermarking module 206, each of which can receive the input prompt 202. The tokenizer 204 can be configured to process the input prompt 202 to convert the text into a sequence of tokens from a vocabulary 208 of the LLM system. The vocabulary 208 can be stored in memory and be accessible by the LLM system 200 during operation. The tokenizer 204 further can map each token to a corresponding token ID to produce a sequence of token IDs that are provided to a neural network 210.

The neural network 210 is trained to generate probability scores corresponding to the tokens (e.g., token IDs) provided by the tokenizer 204. For example, the neural network 210 includes an embedding layer that converts each token ID into a vector representation (embedding vector) and produces a sequence of embedding vectors corresponding to the token sequence. The neural network 210 can include a transformer neural network configured to process the embedding vectors and generate contextualized representations of the tokens based on relationships between tokens in the sequence. The neural network 210 also includes an output layer configured to generate a vector of logits having a dimension defined by the vocabulary 208. Each logit in the vector corresponds represents a score indicating a likelihood that the respective token will be selected as a next token in an output sequence.

In the example of FIG. 4, the watermarking module 206 is configured to cause a processor to perturb logits provided by the neural network 210 in a manner that is semantically aligns with one or more topics. The watermarking module 206 includes a topic extractor 212 configured to identify one or more keywords or topics (T_{detected}) responsive to the input prompt 202. For example, the topic extractor 212 can be implemented as a keyword extraction model, such as a statistical keyword extractor, a graph-based keyword extractor, or an embedding-based keyword extractor. Example keyword extraction methods that can be utilized by the topic extractor 212 include TF-IDF, RAKE, or YAKE, and embedding similarity-based extraction such as KeyBERT or SpaCy. Other extraction methods are possible.

A topic matching/selection function 214 is configured to select a corresponding topic-aligned token list (or lists) 216 based on topic-aligned token data 218 (e.g., topic-aligned token data 102 or 162) and the extracted topics T_{detected} identified by the topic extractor 212. As described herein, the topic-aligned token data 218 green-lists tokens that semantically align with a set of predefined topics determined for the vocabulary 208. For example, the topic-aligned token data 218 includes a respective topic-aligned list of tokens for each respective semantic topic. In some examples, each token is associated with one predefined topic. In other examples, tokens may be included in lists for more than one topic and/or subtopic.

The topic matching/selection function 214 can be configured to match the extracted topics T_{detected} directly with one (or more) of the predefined topics, such as where the extracted keywords or topics exactly matches a topic entry in the set of topics. The topic matching/selection function 214 can provide topic-aligned token list 216 to include the corresponding list that resulted in the match. Also, or alternatively, the topic matching/selection function 214 can be configured to compute embeddings of the input prompt (or extracted topics) and embeddings for the set of predefined topics. For example, the topic matching/selection function 214 can implement an instance of a topic embedding calculator (e.g., calculator 110) to compute the embeddings for the input prompt 202 and the set of predefined topics. The topic matching/selection function 214 can cluster embeddings detected for the input prompt 202 into a small number of centroids (e.g., less than or equal to 5) and compute their similarity (e.g., a cosine or other similarity function) to the embedding computed for each topic (t₁, . . . , t_{K}). The topic list (or lists) having an embedding that is most similar to centroid can be specified in the topic-aligned token list 216 that will be used for watermarking. This ensures that even if an exact match is unavailable, the LLM system 200 still chooses the most semantically aligned topic. The topic-aligned token list 216 can include a list of tokens for the selected topic and/or specify the set of tokens by their token IDs, which are mapped to respective tokens.

A token-topic evaluator 220 is configured to identify which logits generated correspond to tokens included in the topic-aligned token list 216 that is generated for the input prompt 202. The token-topic evaluator 220 can use the topic-aligned list as a topic-aligned token mask or filter for selectively biasing logits. For example, the index values for logits produced by the neural network 210 can be used to associate the logits with respective tokens in the topic-aligned token list 216, such as to identify (e.g., by tagging) a subset of tokens that semantically align with the topic(s) determined for the input prompt. A logit adjustor 222 is configured to adjust the value of logits, corresponding to the subset of tokens identified by the token-topic evaluator 220, based on a bias 224 to provide adjusted logits. The adjusted logits bias token selection, which is performed by LLM decoding 226, toward a topic-based subset of tokens. Logits that are not associated with identified subset of tokens are not adjusted and provided (unmodified) to the LLM decoding 226 along with the adjusted logits. The logit adjustor 222 can adjust the logits by adding a bias value to the logits associated with the identified subset of tokens.

By way example, the logit adjustor 222 can implement the bias by adding a fixed bias value to all logits associated with the identified subset of tokens. Alternatively, the bias can be implemented as an adaptive bias value that the logit adjustor 222 can vary for different tokens that have been identified for biasing. For example, a plurality of bias values can be set for the bias 224, which can be applied to respective tokens selectively based on the token's similarity to the topic (e.g., determined by similarity calculator 114). Also, or alternatively, where there is a hierarchical arrangement of general topics and more specific subtopics, different bias values be used depending on where each of the tokens reside in the topic hierarchy (e.g., a smaller bias can be used for more generalized topics and increasingly larger bias used at increasing levels of specificity). Other adaptive or variable biasing can be used in other examples.

The LLM decoder 226 is configured to generate output text based on the adjusted logits (also including unmodified logits), such that the output text encodes a topic-based watermark. As an example, the LLM decoder 226 can include a probability calculator (e.g., a softmax function) 228, a token sampling (or selection) function 230, and a sequence generator 232. The probability calculator/softmax function 228 is configured to convert the logits, including those produced by the neural network and those adjusted by the logit adjustor 222, into a probability distribution over the tokens in the vocabulary. The probability distribution may then be modified or filtered using techniques such as temperature scaling, Top-k filtering, Top-p (nucleus) filtering, penalties, or other logit/probability adjustment techniques to limit or reshape the candidate token distribution.

The token sampling function 230 is configured to select a token from the filtered probability distribution. In some examples, the token sampling function may randomly sample a token according to the probability distribution, while in other examples the token having the highest probability may be selected (e.g., greedy decoding). The selected token is then appended to the output sequence and converted into a token embedding that is fed back into the neural network 210 as part of the input context for the next decoding step. The neural network then generates a new set of logits conditioned on the updated context that includes the previously generated tokens.

As shown by arrow 236, the process performed by the LLM system 200 (e.g., by neural network 210, watermarking module 206, and decoder 226)—from logit generation, probability calculation, logit adjustment, filtering, and token selection—repeats iteratively for each token in the output sequence until a termination condition is reached, such as generation of an end-of-sequence token, reaching a maximum token length, or meeting another stopping criterion. The sequence generator 232 manages the iterative decoding process and constructs the output token sequence, which corresponds to output text 234 with a topic-based watermark.

In view of the foregoing, the LLM system 200 can improve the internal operation of LLMs by introducing topic-aligned logit biasing during decoding. Unlike arbitrary token partitioning in some existing watermarking methods, tokens are grouped into semantically coherent subsets corresponding to latent topic regions. During decoding (e.g., by LLM decoder 226), a topic corresponding to the input prompt (or evolving hidden state) can be identified. Tokens that are determined to be semantically aligned with that topic are bias-adjusted. Bias magnitude may be fixed or adaptively scaled based on one or more criteria (e.g., topic similarity, confidence metrics, token position, residual token set size, etc.). As described herein, because biasing is semantically consistent with contextual hidden states computational overhead remains bounded and the time to generate text (e.g., latency) can be reduced compared to many existing approaches. Additionally, the approach disclosed herein can achieve high-performance with respect to each of text quality and robustness metrics that is at least comparable to or better than existing approaches.

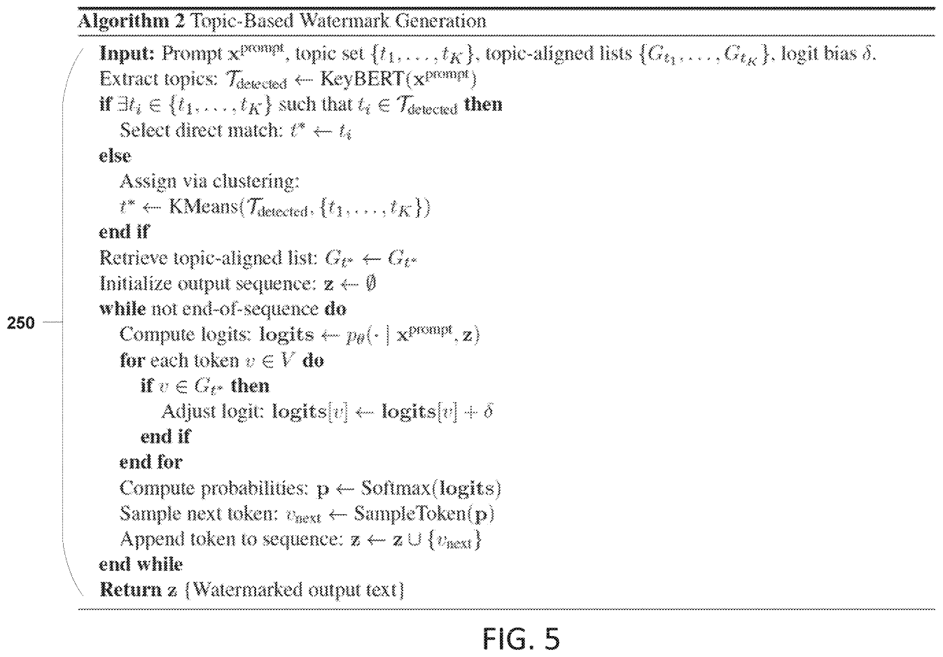

As a further example, FIG. 5 depicts an example algorithm 250 that can be implemented to perform topic-based watermarking. The algorithm 250 can be used to implement the LLM system 200 of FIG. 4 for generating watermarked output text. Accordingly, the description of FIG. 5 can also refer to certain aspects of FIG. 4. The algorithm 250 can receive as inputs an input prompt (x^{prompt}), the topic set {t₁, . . . , t_{K}}, topic aligned lists {Gₜ_{₁}, . . . Gₜ_{_{1K}}}, and logit bias δ.

As shown in the example algorithm 250 of FIG. 5, the input prompt is processed to extract (e.g., by topic extractor 212) one or more topics from the input prompt (e.g., T_{detected}←KeyBERT(x^{prompt})). The algorithm further selects (e.g., by topic matching/selection function 214) one or more topic aligned lists Gₜ, based on the extracted topics T_{detected} and the set of topic aligned lists {Gₜ_{₁}, . . . Gₜ_{_{1K}}}. As described herein, topic aligned lists {Gₜ_{₁}, . . . Gₜ_{_{1K}}} can be static or dynamic.

At each generation step, the model (e.g., neural network 210) produces logits p_{θ}(v|x^{prompt}, z) over the vocabulary V. A small bias δ is added (e.g., by logit adjuster 222) to all tokens v∈Gₜ* before normalizing with a softmax function (e.g., probability calculator/softmax function 228). Intuitively, this raises the selection probability of tokens in Gₜ*, thereby embedding a watermark without introducing multiple decoding passes or inflating perplexity. A larger δ yields a more robust watermark signal at the cost of potentially more noticeable shifts in text style or quality. After adjusting logits, the model samples the next token via standard methods (e.g., token sampling 230). In view of the algorithm, topic extraction and logit biasing constitute minimal overhead compared to typical LLM pipelines, making the topic-based watermarking efficient and effective without significantly increasing latency or degrading fluency.

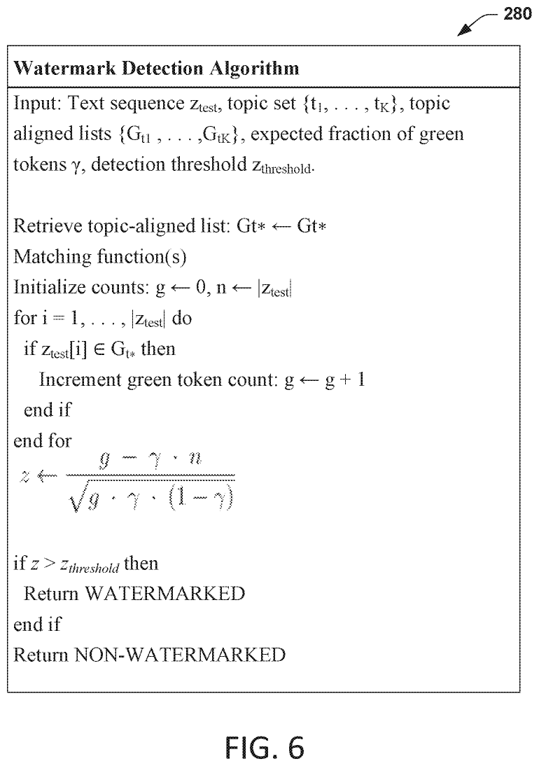

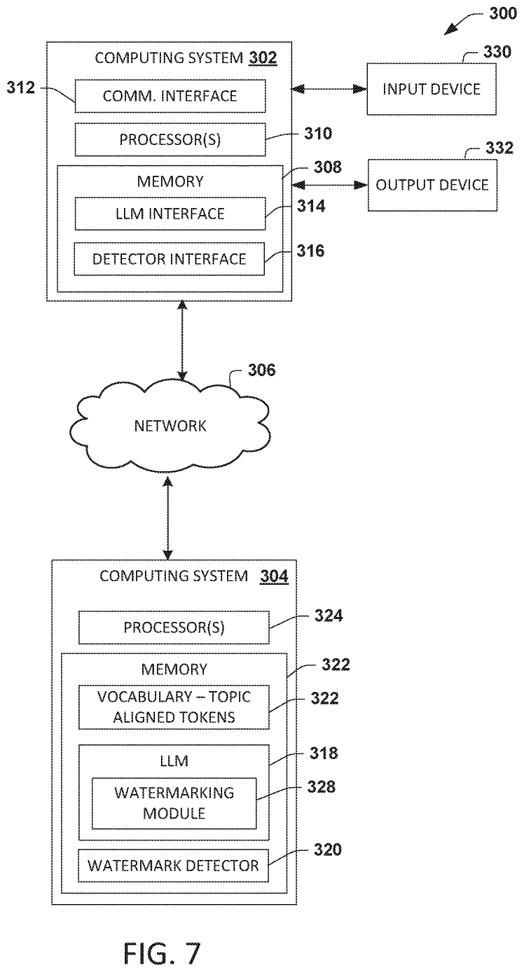

FIG. 6 depicts an example detection algorithm 280 that can be implemented to perform topic-based watermark detection for an input text sequence (zₜₑₛₜ). The text sequence may also be referred to as a test sequence since it is being tested to determine whether it contains a watermark. The detection algorithm 280 can be publicly accessible, such as via a computing system that exposes one or more endpoints configured to receive the input test sequence, while certain parameters remain private. For example, a user or a software agent can employ an API or other interface to upload, transmit, or otherwise provide the input test sequence zₜₑₛₜ to a computing system (see, e.g., FIG. 7) implementing the detection algorithm 280. For example, the algorithm 280 can receive as inputs the input test sequence zₜₑₛₜ, a set of topics {t₁, . . . , t_{K}}, topic aligned lists {Gₜ_{₁}, . . . Gₜ_{_{1K}}}, expected green token fraction (γ), and one or more detection thresholds (z_{threshold}). Additional parameters can include count parameters for a green token count (g) and input token count (i). Responsive to these inputs, the detection algorithm 280 is configured to determine whether the input test sequence zₜₑₛₜ includes a topic-based watermark. As described herein, the detection algorithm 280 may include one or more matching functions.

As an example, the detection algorithm 280 retrieves the topic aligned list G_{t*} and initializes its parameters to starting values. The detection algorithm 280 can implement a hierarchical matching strategy, in which direct topic matching is performed followed by one or more other matching methods, which may or may not include topic extraction.

For example, the detection algorithm 280 can extract high-level topics from zₜₑₛₜ (e.g., using KeyBERT or other topic extraction methods, such as an instance of topic extractor 212). If a direct match to one of the predefined topics {t₁, . . . , t_{K}} exists, the corresponding green list G_{t*}. If extracted topics T_{detected} directly match predefined topics {t₁, . . . , t_{K}}, a corresponding green list G_{t*} can be selected from the set of topic aligned lists {Gₜ_{₁}, . . . Gₜ_{_{1K}}} and a green token count incremented. Otherwise, if no direct match is identified, the detection algorithm 280 can perform semantic mapping to ensure consistency with the generation-time topic selection.

As an example, the detection algorithm 280 can utilize embedding averaging to compute the mean embedding of all detected topics and identify the predefined topic with highest cosine similarity, where

$${\overline{e}}_{detected} = \frac{1}{m} {\sum }_{i = 1}^{m} {e}_{{d}_{i}}$$

and selects t*=argmaxₜ_{ⱼ}sim(ē_{detected}, eₜ_{ⱼ}). K-means clustering further can be employed to capture topic diversity within the detected set by applying k-means to detected topic embeddings and evaluating centroids against predefined topics: t*=argmaxₜ_{ⱼ} max_{c}_{ₖ} sim(cₖ, eₜ_{ⱼ}).

The detection algorithm 280 further can be configured to count how many tokens (the parameter g) in zₜₑₛₜ belong to G_{t*}, where g represents the total and n=|zₜₑₛₜ|, and compute a z-score using the selected topic lists G_{t*} For example, the detection algorithm 280 can be configured to compute the z-score comparing the observed green-token fraction to the expected baseline γ, such as:

$$z = \frac{g - γ \cdot n}{\sqrt{n \cdot γ \cdot ( 1 - γ )}}$$

If z>z_{threshold}, the detection algorithm 280 can conclude that zₜₑₛₜ is WATERMARKED; otherwise, it is labeled NON-WATERMARKED. The threshold z_{threshold} can be tuned (e.g., in response to a user input) to manage false positives versus missed detections.

As another example, the detection algorithm 280 can implement a sliding window detection to address local topic inconsistencies while maintaining semantic awareness through temporal aggregation. For example, the extracted input text can be partitioned into windows of size w. For each window, the detection algorithm 280 can employ a topic extraction method (e.g., an instance of topic extractor 212) to extract topics using the hierarchical matching described above, then assign the final topic via majority voting: t*=argmaxₜ_{ⱼ}|{wᵢ: topic(wᵢ)=tⱼ}|, where topic wᵢ represents the assigned topic for window wᵢ. An adaptive fallback mechanism can select embedding averaging for windows with fewer than 3 detected keywords, for example. Detection proceeds using the same z-score computation as strict matching.

As another example, the detection algorithm 280 can implement a maximum z-score detection approach, which does not include topic extraction. The other methods (e.g., topic matching and sliding window methods) rely on successful topic extraction, which can fail with ambiguous or multi-topic content. Accordingly, the maximum z-score detection method omits the topic extraction and operates by evaluating text against each predefined green list Gₜᵢ, and computing the corresponding z-score zᵢ using the same statistical framework as previous methods. The final classification uses the maximum z-score across all topics: t*=argmaxₜ_{ⱼ} zᵢ. This approach effectively allows the watermark signal itself to determine the most likely topic alignment. This parameter-free approach provides several advantages: (i) it requires no topic extraction or mapping steps, eliminating potential failure modes; (ii) it leverages the embedded watermark signal to guide topic selection, aligning detection with the generation process; and (iii) it provides robustness against topic ambiguity, drift, and misalignment, making it suitable for practical deployment where topic alignment cannot be guaranteed.

An example of program code that is configured to implement each of the algorithms 180, 250, and 280 is available online at https://anonymous.4open.science/r/Topic-Based-Watermarks-C7D3/, and the program code set forth at such location is incorporated herein by reference.

FIG. 7 is a block diagram of an example computing environment 300 that can be configured to perform topic-based watermarking and/or topic-based watermark detection, as described herein. The computing environment 300 includes a number of computing systems 302 and 304. In an example, the computing system 302 can be a server associated with (or controlled by) one or more users and the computing system 304 can be implemented or controlled by a third party (e.g., an owner or operator) and may operate autonomously based on an agent configured to receive requests and provide responses. Each of the computing systems 302 and 304 can be coupled to each other through one or more communication links, shown as including a network 306. The network 306 can include hardware, software, and/or firmware to enable communications of data between the computing systems 302 and 304 through one or more physical (e.g., wired or optical) and/or wireless communication links, such a can form part of one or more local area networks, wide area networks, etc. While two computing systems 302 and 304 are shown in the example, the computing environment 300 can include any number of computers, which can be controlled or operated by a human user and/or an automated agent.

As an example, the computing system 302 includes memory 308, which can include one or more non-transitory machine-readable media to store data and executable instructions (e.g., program code). The computer 302 can also include one or more processors 310, each of which can include one or more processing cores, to access the memory 308 and execute corresponding instructions. The computing system 302 can also include one or more communication interface 312 configured to enable communication between the computing systems 302 and 304. For example, the communications interface 312 can include a wireless communications network device configured to communicate data through a wireless network (e.g., network 306), such as a Wi-Fi, Bluetooth, or a cellular data link. Also, or as an alternative, the communications interface 312 can include a physical communications network device configured to communicate data through a wired or optical network (e.g., network 306), such as Ethernet, fiber channel, or the like. Also, or as an alternative, the communications interface 312 can be configured to implement secure connection (e.g., encrypted data communications) through the network 306.

In the example of FIG. 7, the instructions in the memory 308 include program code (e.g., methods or functions), including an LLM interface 314 and a detector interface 316. The memory 308 can include other program code (not shown) to perform the functions described herein, such as a web browser, such as a web browser, client application, background service, data processing utilities, communication software, or other executable programs.

As an example, the LLM interface 314 can be implemented as an application programming interface (API), software development kit (SDK), command-line interface (CLI), or other communication interface (e.g., a web-based portal, remote procedure call (RPC) interface, or message queue) configured to upload, transmit, or otherwise provide an input prompt (or query) to the computing system 304 implementing an LLM 318. The LLM 318 can be configured to perform topic-based watermarking such as described herein (see, e.g., FIGS. 4 and 5). In some implementations, the input prompt may be encapsulated within a structured data format (e.g., JSON, XML, or protocol buffers) and communicated over a network using one or more communication protocols (e.g., HTTP/HTTPS, WebSocket, gRPC, or TCP/IP). The detector interface 316 can be similarly configured (e.g., an API, SDK, CLI, or other communication interface) to upload, transmit, or otherwise provide the input text sequence to the computing system 304 implementing a watermark detector 320. In some examples, the input prompt to text sequence provided from the computing system 302 may be encapsulated within a structured data format (e.g., JSON, XML, or protocol buffers) and communicated over the network 306 using one or more communication protocols (e.g., HTTP/HTTPS, WebSocket, gRPC, or TCP/IP).

Additionally, while the example of FIG. 7 demonstrates the LLM 318 and watermark detector 320 on the same computing system 304, in other examples, the executable program modules may be implemented on different computing systems, such as in a cloud computing environment, virtual machine, containerized environment, server cluster, or other distributed computing architecture. In such examples, the program modules may be communicatively coupled via one or more networks and may cooperatively perform the functions described herein, with processing tasks distributed among the multiple computing systems.

The computing system 304 includes memory 322, which can include one or more non-transitory machine-readable media, to store executable instructions and data. The computing system 304 can also include one or more processors 324, each of which can include one or more processing cores, to access the memory 322 and execute corresponding instructions, which can be based on data received from the computing system 302. The executable instructions can include the LLM 318 and the watermark detector 320. The memory 322 can also store data including an LLM vocabulary and topic-aligned token data 326. As described herein the topic-aligned token data 326 can include lists of tokens associated with one or topics and/or subtopics. The topics and/or subtopics can be static or dynamic during operation.

The memory 322 can also store data received from one or more other computing systems 302, including input prompts, text sequences, metadata, configuration information, processing results, intermediate data, and other information associated with the systems and methods described herein. The data may be stored in volatile or non-volatile memory and may be organized in one or more data structures, databases, files, or memory buffers for access by the processor during execution of the LLM 318 and/or watermark detector 320. The computing system 304 includes one or more communication interfaces (not shown) configured to enable communication with the computing system 302 and one or more other computers (also not shown). Is some examples, the computing system 304 may expose one or more endpoints configured to receive the input test sequence, optionally along with metadata (e.g., timestamps, identifiers, source information, or configuration parameters), and may perform validation, authentication, and/or preprocessing (e.g., normalization or feature extraction) on the received data inputs. The LLM 318 can be implemented by the LLM system 200, the algorithm 250, or as otherwise described herein. The LLM 318 can include a watermarking module 328 (e.g., watermarking module 206) to semantically bias token selection probabilities as described herein.

As an example, the computing system 302 can provide an input prompt to the LLM 318 via the LLM interface 314. The input prompt can be entered at the computing system 302 in response to a user input received via one or more input devices 330 (e.g., keyboard, mouse, touchscreen, microphone, camera, or other input device). For example, a user may manually enter text, speak a voice command that is converted to text, select one or more options via a graphical user interface, or otherwise provide input that is converted into the input prompt. Alternatively, the input prompt can be generated automatically by an agent, script, application, or other program executed by the processor 310. Thus, in some examples, the input prompt may be generated without direct user interaction and provided to the LLM 318 programmatically, such as by a third-party service.

The LLM 318 is configured to process the input prompt from the computing system 302 and generate output text that includes a topic-based watermark, as described herein. For example, the watermarking module 328 is configured to bias token selection probabilities in favor of tokens that semantically align with one or more topic(s) determined for the input prompt. For example, the watermarking module 328 can apply the bias by modifying logits generated by LLM for a subset of tokens in the aligned subset of tokens, such as described herein. Alternatively, the bias could be applied in a reverse manner by modifying logits generated by LLM for a subset of tokens that do not semantically align with the input prompt (e.g., by reducing logits for non-aligned tokens). The biasing can be fixed or be adaptive for such tokens to which the biasing is applied. The LLM 318 can provide the output text from the computing system 304 to the computing system 302 via the LLM interface 314.

For example, the output text may be transmitted as a response message via the LLM interface 314 using a structured data format (e.g., JSON, XML, or another format). The computing system 302 can receive the output text via the LLM interface 314 and store the received text in the memory 308. The computing system 302 may then generate an output to an output device 332, such as a display, screen, speaker, printer, or other output device, to present the output text to a user or another system.

In another example, the computing system 302 can provide an input text sequence to the watermark detector 320 (e.g., implementing detection algorithm 280) via the detector interface 316. The input text sequence can be selected at the computing system 302 in response to a user input received via one or more input devices 330, and the input text sequence may be obtained (e.g., as a file or document) from a user, a third-party platform, an entity, an online service, a database, or another computing system. Alternatively, the input text sequence can be automatically submitted by an agent, script, application, or other program executed by the processor 310, for example by retrieving the input text sequence from a remote computing system, database, web service, or application programming interface and providing the input text sequence to the systems described herein.

As described herein, the watermark detector 320 is configured to process the input text sequence from the computing system 302 and generate a response indicating whether the input text sequence is watermarked or non-watermarked. For example, the presence of a watermark is determined by counting a number of tokens in generated text that belong to a topic-aligned token subset and comparing the count to an expected number of such tokens based on a baseline probability. A statistical metric, such as a z-score, binomial probability, likelihood ratio, or other hypothesis test statistic, may be computed to determine whether the observed frequency of topic-aligned tokens deviates from the expected baseline frequency by more than a threshold amount. If the statistical metric exceeds a threshold value, the system determines that the generated text likely contains an embedded watermark.

The detection result can be transmitted from the computing system 304 to the computing system 302. The computing system 302 can receive a response via the detector interface 316 and store the received text in the memory 308. The computing system 302 may then generate an output to an output device 332, such as a display, screen, speaker, printer, or other output device or GUI, to present the output text to a user or another system.

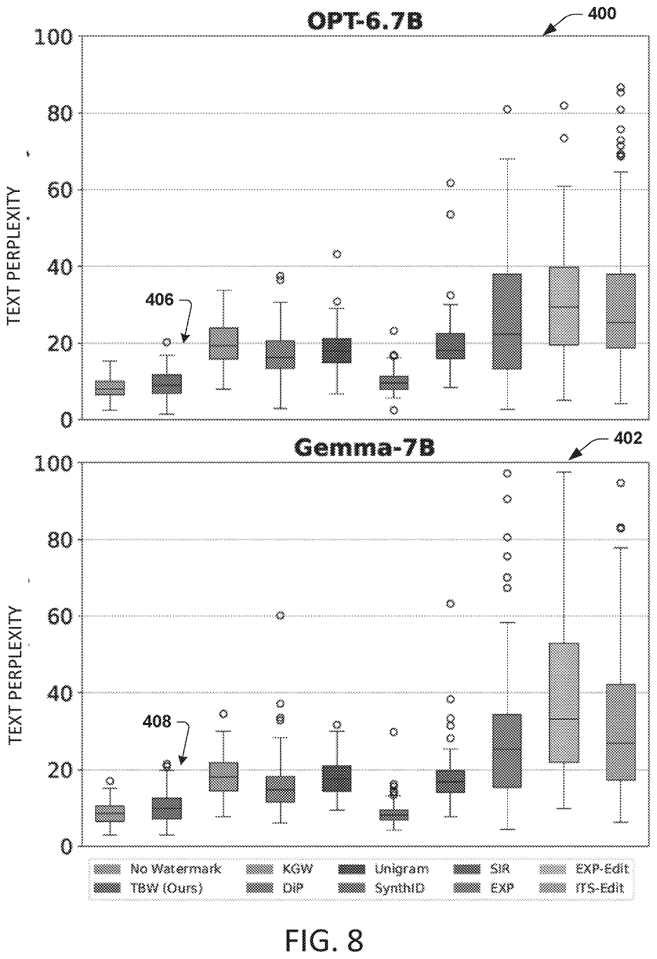

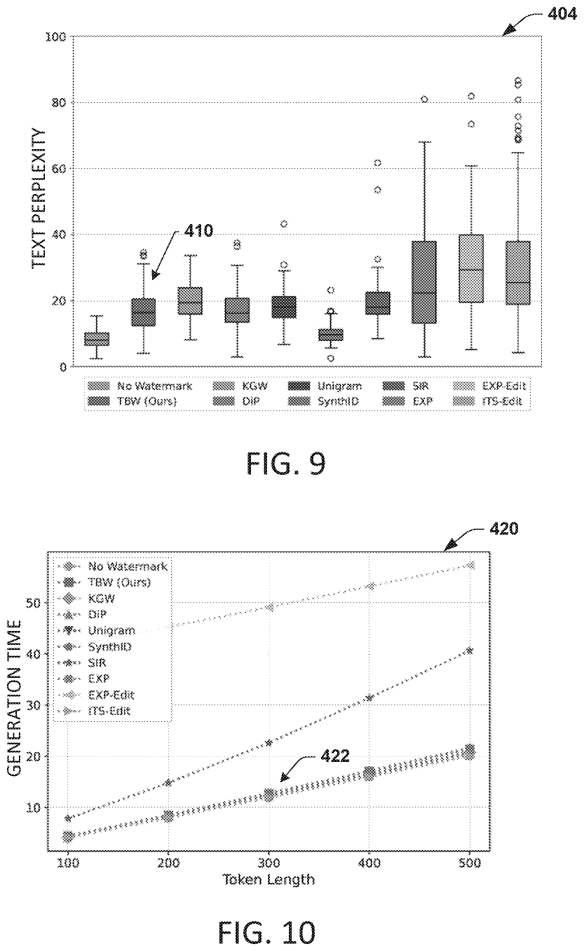

FIGS. 8 and 9 includes graphs 400, 402, and 404 depicting a comparison of text perplexity for a plurality of different LLMs. For example, graphs 400, 402, and 404 illustrate text perplexity for a plurality of different watermarking methods including the approach disclosed herein, shown at 406, 408, and 410. In FIGS. 8 and 9 lower text perplexity indicates higher generated text quality. Accordingly, the topic-based watermarking disclosed herein can achieve significantly lower perplexity (higher text quality) compared to other watermarking schemes, specifically SynthID, further closely matching non-watermarked outputs.

FIG. 10 is a graph 420 demonstrating a comparison of generation time for different watermarking methods at different token lengths. The efficiency overhead introduced by each watermarking method was measured, using 10 samples from the C4 dataset (see, e.g., https://www.tensorflow.org/datasets/catalog/c4) and generating sequences of lengths {100, 200, 300, 400, 500}. For each token-length setting, the average generation time over the 10 samples was recorded. As shown at 422, the watermarking approach disclosed herein introduces negligible overhead relative to non-watermarked generation across all sequence lengths, matching lightweight methods (e.g., KGW, SynthID, Unigram). In contrast, EXP-Edit requires multiple re-ranking passes and SIR incurs additional complexity, resulting in noticeably higher generation times. These trends hold consistently across both model scales, confirming the practicality of deploying the systems and methods disclosed herein.

FIG. 11 are graphs 430, 432, 434, and 436 demonstrating a comparison of true positive rate at false positive rate for different watermarking methods including the approach disclosed herein, shown by plots 438, 440, 442, and 444, respectively. As shown in graphs 430 and 434, for OPT-6.7B, the plots 438 and 442 show the approach disclosed herein achieves comparable robustness to Unigram, demonstrating strong detection performance. For GEMMA-7B, shown as plots 440 and 444 in graphs 432 and 436, respectively, there is a slight reduction in robustness; however, this trade-off comes with improved text quality. The difference in AUC between our method and Unigram is minimal, approximately 4%, high-lighting the balance between robustness and text quality that the systems and methods disclosed herein can achieve.

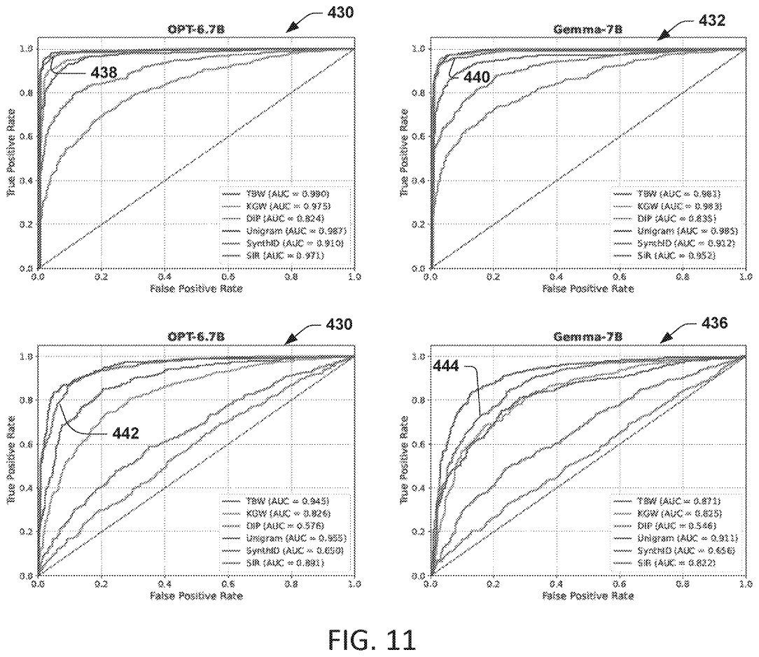

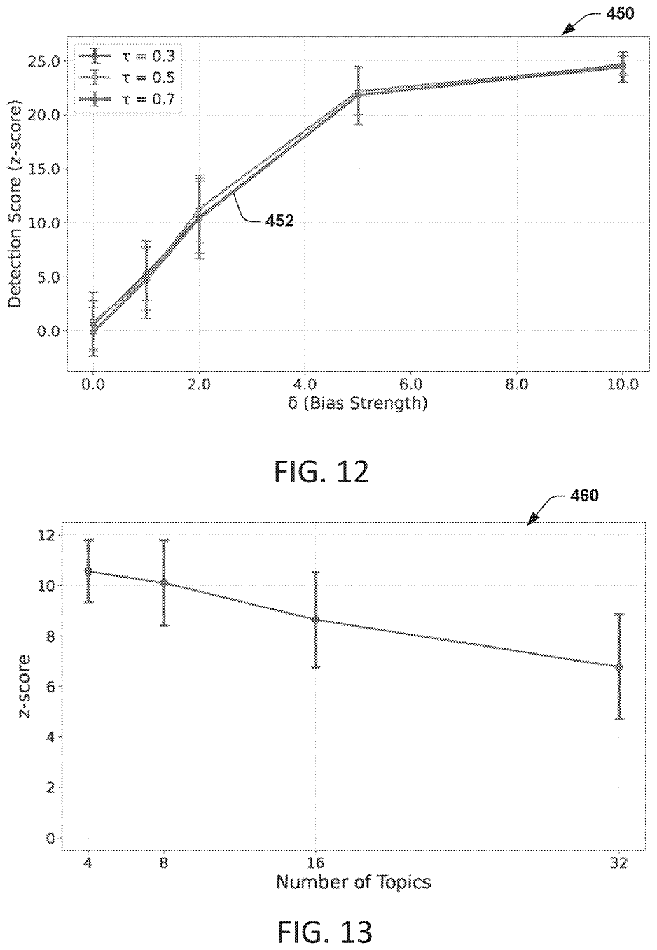

FIG. 12 is a graph 450 demonstrating a comparison of detection scores as a function of bias strength for topic-based watermarking disclosed herein (shown at 452). FIG. 12 demonstrates that a higher δ yields stronger watermark signals, with detection saturating around δ=5.0.

FIG. 13 is a graph 460 demonstrating an example of detection strength as a function of the number of topics for topic-based watermarking implemented according an example embodiment. FIG. 13 reports the mean z-score under maximum-z as a function of K. As expected, the signal decreases as K grows, yet remains strong: from ~11 at K=4 down to ~7 at K=32. Notably, even at K=32, the z-scores are comparable to, if slightly below, Unigram and KGW baselines at the same δ, despite having smaller per-list partitions.

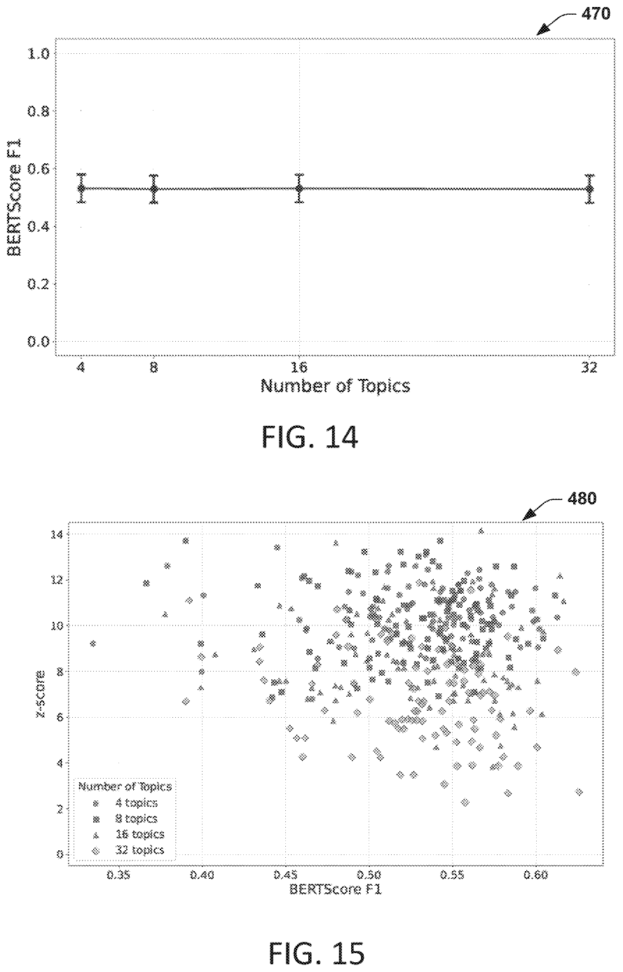

FIG. 14 is a graph 470 demonstrating an example of text-quality metric (e.g., BERTScore F1) as a function the number of topics for topic-based watermarking implemented according an example embodiment. The graph 470 shows no degradation as K increases with scores remaining flat with low variability. This indicates that relaxing τ to 0.5, in order to maintain reasonable per-topic coverage, together with a moderate δ=2.0, preserves fluency and semantics.

FIG. 15 is a scatter plot 480 showing detection z-scores as a function of text quality for topic-based watermarking, namely, z-score against BERTScore F1 across all K. Most points cluster in z∈[8, 12] and F1∈[0.50, 0.60], with the K=32 points shifted modestly lower in z (consistent with FIG. 13) but without a quality penalty. Larger K thus modestly weakens the detectable signature while keeping quality stable.

In view of the foregoing, across all metrics, the topic-based watermarking systems and methods disclosed herein strike the most favorable balance relative to prior watermarking schemes. In terms of accuracy, topic-based watermarking's maximum z-score detection consistently achieves near-perfect ROC-AUC (>0.99), remaining competitive with more expensive multi-pass schemes. On robustness, topic-based watermarking substantially out-performs lightweight methods such as SynthID and KGW under both lexical perturbation and full-text paraphrasing, closing much of the gap to heavy-weight approaches (e.g., EXP, ITS-Edit) without their quality degradation. Finally, in efficiency, topic-based watermarking introduces negligible generation overhead, matching production-ready systems while delivering robustness gains that prior efficient schemes cannot achieve. Taken together, these results underscore the practicality for real-world deployment of the topic-based watermarking systems and methods disclosed herein.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a robotically controlled painting tool, a medical device, or other type of tool.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), central processing units (CPUs), graphics processing units (GPUs), tensor processing units (TPUs), neural processing unit (NPUs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements, any of which would constitute a processor as used herein. The system may operate in a stand-alone computing device, a client-server environment, a cloud computing environment, or a distributed computing system.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the subject disclosure. The sequence of operations (or steps) is not limited to the order presented in the claims or figures unless specifically indicated otherwise.

Modifications are possible in the described embodiments, and other embodiments are possible, within the scope of the claims.

All publications identified herein are incorporated by reference in their entireties.

What is claimed is:

1. A computer-implemented method, comprising:
receiving, at language model, an input prompt;
determining a semantic topic associated with the input prompt;
adjusting token selection probabilities to favor tokens aligned with the semantic topic; and
generating output text using the adjusted probabilities, whereby usage of tokens in the output text encodes a topic-based watermark.

2. The method of claim 1, further comprising:
selecting, from a vocabulary of the language model, a subset of tokens associated with the semantic topic.

3. The method of claim 2, wherein adjusting token selection probabilities comprises adding a bias to logits corresponding to tokens within the subset of tokens prior to sampling to increase a likelihood of selecting tokens within the subset.

4. The method of claim 3, wherein the bias includes a fixed value for tokens within the subset of tokens.

5. The method of claim 3, wherein the bias includes an adaptive value.

6. The method of claim 2, wherein the semantic topic is one of a plurality of predefined topics, the vocabulary is partitioned into respective token subsets, and each token subset is associated with a respective one of the predefined topics.

7. The method of claim 2, wherein the semantic topic comprises one or more of a plurality of predefined topics and/or subtopics, the vocabulary is partitioned into respective token subsets, and each token subset is associated with a respective one of the predefined topics and/or subtopics.

8. The method of claim 7, wherein adjusting token selection probabilities comprises adding a bias to logits corresponding to tokens within the subset of tokens prior to sampling to increase a likelihood of selecting tokens within the subset, the bias having value that is variable depending on which of the predefined topics and/or subtopics the selected subset of tokens is associated.

9. The method of claim 2, wherein the semantic topic is one of a plurality of predefined topics and determining the semantic topic comprises:
extracting topics based on the input prompt, and at least one of:
directly matching the extracted topics with one of the predefined topics; and/or
computing an embedding of the input prompt and identifying a nearest topic cluster based on the embedding.

10. A non-transitory machine-readable medium having machine executable instructions that, when executed by one or more processors, cause the one or more processors to perform the method of claim 1.

11. A system, comprising:
one or more processors; and
memory storing machine-readable instructions that, when executed by the one or more processors, cause the one or more processors to at least:
receive an input prompt;
generate, based on the input prompt, logits for candidate tokens using a large language model;
adjust the logits to bias token selection toward a topic-based subset of tokens; and
generate output text using the adjusted logits, whereby usage of tokens in the output text encodes a topic-based watermark.

12. The system of claim 11, wherein the instructions further cause the one or more processors to determine a semantic topic associated with the input prompt, in which the semantic topic is one of a plurality of predefined topics for a vocabulary of the large language model.

13. The system of claim 12, wherein the instructions further cause the one or more processors to select, from a vocabulary of the language model, the subset of tokens based on the semantic topic determined for the input prompt.

14. The system of claim 12, wherein the instructions to determine the semantic topic, further cause the one or more processors to:
extract topics based on the input prompt, and at least one of:
directly match the extracted topics with one of the predefined topics; and/or
compute an embedding of the input prompt and identifying a nearest topic cluster based on the embedding.

15. The system of claim 12, wherein the vocabulary is partitioned into respective token subsets, and each token subset is associated with a respective one of the predefined topics.

16. The system claim 12, wherein the semantic topic comprises one or more of a plurality of predefined topics and/or subtopics, the vocabulary is partitioned into respective token subsets, and each token subset is associated with a respective one of the predefined topics and/or subtopics.

17. The system of claim 11, wherein the bias includes a fixed or adaptive bias value, and the logits are adjusted by adding the fixed or adaptive bias value to the logits associated with the subset of tokens.

18. The system of claim 11, wherein the instructions to generate output text further cause the one or more processors to:
generate a probability distribution from the adjusted logits;
sample a token from the probability distribution;
append the sampled token to a sequence of tokens, wherein the output text is generated based on the sequence of tokens.

19. A computer-implemented method of detecting watermarking in text, comprising:
receiving a text sequence;
computing a score representing a frequency of tokens for the text sequence associated with at least one topic of a plurality of predefined semantic topics for a vocabulary of a large language model;
comparing the score to a threshold; and
determining whether the text sequence includes a watermark based on the comparison.

20. The method of claim 19, further comprising:
identifying a candidate topic for the text sequence from the plurality of predefined topics, wherein the score is determined based on a frequency of tokens for the text sequence matching a subset of tokens associated with the candidate topic.
